(19) United States
(12) Patent Application Publication
(10) Pub. No.: US 2017/0165149 A1
(43) Pub. Date: Jun. 15, 2017

(54) Clitoral Stimulation Apparatus

(71) Applicant: Beverly Brouse, Akron, OH (US)

(72) Inventor: Beverly Brouse, Akron, OH (US)

(21) Appl. No.: 14/969,205

(22) Filed: Dec. 15, 2015

(51) Int. Cl. A61H 19/00

(52) U.S. Cl. CPC A61H 19/34; A61H 19/32

(57) ABSTRACT

A pillow-like bisected ellipsoid shape clitoral stimulation apparats is introduced for use during missionary style intercourse. This non-mechanical stimulation apparatus is unique over conventional art providing a user with a solid yet yielding device with physical characteristics conducive for use during intercourse while comfortably providing desired pressure to the clitoris. The device is designed for direct pressure to the clitoris while providing a soft sensation against the body when the woman is under the man. Unlike most clitoral stimulation devices made of hard solid materials, the present invention offers enough direct pressure without the rigid attributes that can cause discomfort when used during intercourse.

### FIELD OF INVENTION

The present invention relates generally to sex toy devices, and more specifically, an apparatus specifically designed for bridging the space between a man's pelvic area and a woman's clitoris for desired pressure and stimulation without discomfort.

### BACKGROUND OF INVENTION

The inventor came up with the invention while acknowledging she could only climax during missionary style intercourse when she was in the dominant position (on top). She discovered that while her spouse was in the dominant position, there lacked any clitoral stimulation. Understanding that the majority of women climax from their clitoris rather than their internal G-spot, she sought out an apparatus that would bridge the gap between her husband's pelvic bone and her clitoris, thus, creating a comfortable pressure point to achieve climax. She experimented with pillows and like objects but found they lacked the stability necessary for providing the desired concentrated pressure. Traditional clitoral simulators were too hard and caused discomfort when placed on clitoris during intercourse. Her search for a non-rigid apparatus designed for clitoral stimulation during intercourse left her empty handed. She envisioned a product flexible enough to absorb some of the pressure imposed by the weight of her spouse yet sturdy enough to not collapse completing but provide enough pressure to comfortably stimulate the clitoris.

### BACKGROUND OF INVENTION & RELATED ART

Prior art in the sex toy industry specific to clitoral stimulation are typically designed for foreplay with vibrating features and are not conducive for external stimulation during intercourse due to their hard and unyielding casings.

Other prior art sex toy apparatuses meant for sexual pleasure are constructed out of jelly-like materials not conducive for external stimulation during intercourse due to their sticky attributes that may cause pinching of the skin or clitoris during repetitive movements or friction.

There are no known prior art for a yielding non-mechanical clitoral stimulator specifically designed for bridging the gap between a man's pelvic bone and a woman's clitoris, in the field of adult sex toys specifically. Traditional clitoral stimulators have a hard body and typically contain internal mechanics making them non-conducive for direct use over the clitoris during intercourse.

### SUMMARY OF INVENTION

The present invention provides a cushioned bisected ellipsoid shape clitoral stimulation device specifically designed for use against the clitoris during missionary style intercourse. When the man is in the dominant position, the leveled yielding underside design allows for a comfortable fit against the man's pelvic bone while the elliptical top provides the desired pressure against the woman's clitoris.

The cushion-like attributes along with the customized slip cover allows for minimal sliding during rapid movement while the foam internal construction with concentrated dense core provides the right amount of pliability and stiffness.

The cover allows for the possibility of different textiles while protecting the internal construction and allowing for easy cleaning.

In accordance with the embodiment of the invention there is a cushioned clitoris stimulation apparatus, comprising: a dense body made of high-quality polyurethane foam with a concentrated dense core; and a cover for ease of cleaning and possible variations of textiles.

### BRIEF DESCRIPTION OF THE DRAWINGS

These and other objects and features of the present invention will become apparent to the reader through a consideration of the Detailed Description of the Invention when considered in conjunction with the drawing figures in which:

FIG. 1 is a top view of the clitoral stimulator apparatus

FIG. 2 is a bottom view of the clitoral stimulator apparatus

FIG. 3 is a side view of the clitoral stimulator apparatus

FIG. 4 is a top view of the clitoral simulator apparatus without cover

### DETAILED DESCRIPTION OF INVENTION

There is provided herein a cushioned bisected ellipsoid shaped clitoral stimulating apparatus. The device is designed to comfortably bridge the gap between a man's pelvic bone and a woman's clitoris, when the man is in the dominant position during missionary style intercourse. Unlike traditional clitoral stimulation devices, the present invention is yielding and gentle enough for use against the clitoris during the act of intercourse. Its cushioned body and concentrated core make for an idealistic stimulating instrument for the clitoris when excess pressure is applied.

The apparatus is preferably constructed from a dense polyurethane foam molded into a bisected elliptical-shaped design for a desired fit between a man's pelvic bone and a woman's clitoris. The apparatus may or may not take the form of different shapes such as a square, rectangle, triangle or any other varying shape or size.

Exterior is preferably fabricated from a cotton, polyester blend material. The outside cover is preferably detachable, and may or may not be constructed from other forms of material or textiles. The various textiles provide sensations that could include, but are not limited to, soft and velvety, smooth and silky, rough and bumpy, slick and even prickly which could consist of materials such as silk, satin, polyester, vinyl or like fabrics. The leveled underside may or may not include a non-skid design or fabrication.

A convex or rounded concentrated core is preferably constructed within the foam apparatus and not accessible for removal. The core may or may not be positioned in the direct center of the apparatus. The concentrated core is preferably made from dense foam material but may be made from other materials such as latex, plastic or silicone.

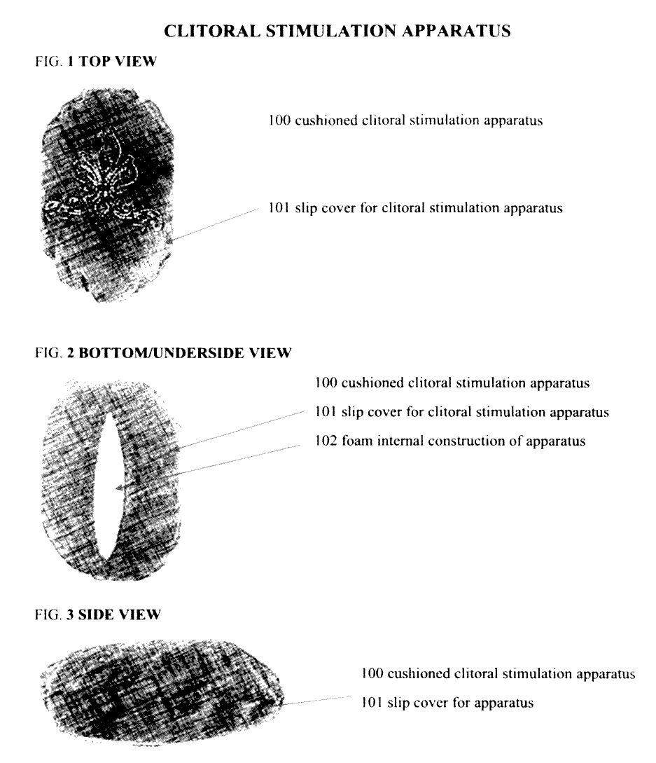

With reference to FIGS. 1-4, there is shown a cushioned clitoral stimulation apparatus 100 measuring between 3 to 6 inches in length and 3 to 5 inches in width, preferably 5 inches in length and 4 inches in width. It is sized to lay comfortably between a man's pelvic region and a woman's clitoris during missionary style intercourse. The exact dimensions are not critical.

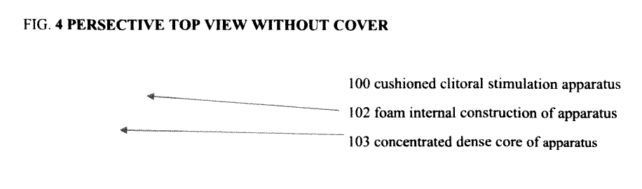

The slip cover 101 can be seen in FIGS. 1-3 providing protection for the foam internal construction 102 and concentrated dense core 103 as seen in FIG. 4.

The modifications, changes and improvements, within the scope of the invention, will now be apparent to the reader.

What is claimed is:

1. A solid pillow-like bisected ellipsoid shaped apparatus with no internal working parts for clitoral stimulation during intercourse, comprising: a dense body made of high-quality polyurethane foam with a dense core; enclosed in a removable cotton/polyester blend cover.

2. The solid pillow-like apparatus of claim 1 wherein the dense center allows for a stabilizing feature against provided pressure; that may or may not be centrally located within the apparatus; that may or may not be made of a more condensed foam material.

3. The solid pillow-like apparatus of claim 1 wherein the cover allows for easy cleaning and interchanging textiles; the cover may or may not be removable and can be constructed of different textiles.
